(19) United States
(12) Patent Application Publication
(10) Pub. No.: US 2026/0360088 A1
(43) Pub. Date: Nov. 12, 2026

(54) ADAPTING METAVERSE ENVIRONMENTS BASED ON AGGREGATED PHYSICAL CONTEXT OF THE PARTICIPANTS

(71) Applicant: INTERNATIONAL BUSINESS MACHINES CORPORATION, ARMONK, NY (US)

(72) Inventors: MARTIN G. KEEN, CARY, NC (US); SARBAJIT KUMAR RAKSHIT, KOLKATA (IN); CAROLINA GARCIA DELGADO, ZAPOPAN (MX); TUSHAR AGRAWAL, WEST FARGO, ND (US)

(21) Appl. No.: 19/202,063

(22) Filed: May 8, 2025

(51) Int. Cl. G06T 19/00; G06V 20/20; G06V 20/52

(52) U.S. Cl. CPC G06T 19/006; G06V 20/20; G06V 20/52; G06T 2219/024

(57) ABSTRACT

A method and system for adapting a metaverse environment receives physical data related to a physical environment for each of a plurality of participants. The system determines a level of virtual immersion for each of the plurality of participants based on activities of each of the plurality participants in the metaverse, the physical data received and safety threshold data associated with the physical environment for each of the plurality of participants. The system predicts movement of at least one object in the physical environment of one of the participants based the safety threshold data and based on mobility data associated with the object. The system monitors a metaverse collaboration between each of the plurality of participants and changes the level of the virtual immersion for at least one of the plurality of participants based the predicted movement of the at least one object.

### BACKGROUND

The present disclosure relates to methods, apparatus, and products for adapting a metaverse environment.

Extended reality (XR) is an umbrella term that has been used to refer to various different forms of immersive technologies, including virtual reality (VR), augmented reality (AR), mixed reality (MR), cinematic reality (CR), and diminished reality (DR). Generally speaking, XR technologies allow virtual world (e.g., digital) objects from the metaverse to be brought into “real” (e.g., non-virtual) world environments and real world objects to be brought into virtual environments, e.g., via overlays or other mechanisms. Within this context, the term “metaverse” is typically used to describe the convergence of a virtually enhanced physical reality and a persistent virtual space, e.g., a physically persistent virtual space with persistent, shared, three-dimensional virtual spaces linked into a perceived virtual universe. XR technologies may have applications in fields including architecture, sports training, medicine, real estate, gaming, television and film, engineering, travel, and others.

Metaverse collaboration is redefining how people work, socialize, learn and engage in workflow related activities. It's a space where individuals from around the globe can come together to brainstorm ideas, attend virtual conferences, share experiences, and even engage in team-building exercises. Whether it is a virtual office, a classroom, or a virtual concert, the metaverse is connecting people in ways that could only be dreamed of a few years ago. However, the importance of safety in the physical area from which participants attend the metaverse is critical. Participants may be so engrossed in their metaverse workflow experience that they are unaware of potential hazards in their physical surroundings.

### SUMMARY

According to embodiments of the present disclosure, various methods, apparatus and products for adapting a metaverse environment are described herein. In some aspects, a method and system for adapting a metaverse environment receives physical data related to a physical environment for each of a plurality of participants. The system determines a level of virtual immersion for each of the plurality of participants based on activities of each of the plurality participants in the metaverse, the received physical data and safety threshold data associated with the physical environment for each of the plurality of participants. The system predicts movement of at least one object in the physical environment of one of the participants based the safety threshold data and based on mobility data associated with the object. The system monitors a metaverse collaboration between each of the plurality of participants and changes the level of the virtual immersion for at least one of the plurality of participants based on the predicted movement of the at least one object.

### BRIEF DESCRIPTION OF THE DRAWINGS

FIG. 1 sets forth an example computing environment according to aspects of the present disclosure.

FIG. 2 sets forth a block diagram illustrating an example of a participant metaverse immersion adaptor according to aspects of the present disclosure.

FIG. 3 sets forth a flowchart of a method for adapting metaverse environments based on aggregated physical contexts of participants according to aspects of the present disclosure.

FIGS. 4A-4D is a diagram illustrating operations of a participant metaverse immersion adaptor according to aspects of the present disclosure.

FIG. 5 is a flowchart of a method for adapting metaverse environments based on aggregated physical contexts of participants according to aspects of the present disclosure.

### DETAILED DESCRIPTION

While the metaverse offers almost limitless opportunities for collaboration and engagement, it presents a unique paradox: participants can be fully immersed in a virtual environment workflow while physically located in the real world. This duality introduces safety concerns for the participants within the workflow that cannot be ignored. Participants may be so engrossed in their metaverse workflow experience that they are unaware of potential hazards in their physical surroundings due to the participants moving in their physical environment and objects moving in the participants’ physical environment.

Participants can join a collaborative metaverse workflow environment from their respective physical locations. While they are in their physical surroundings, they can engage in various physical activities. However, in some cases, these activities may carry certain risks in their physical environment. For example, a participant that is in a manufacturing plant that is operating virtual equipment may be at risk due to surrounding equipment that is moving. In such situations, when participants engage in these activities or move around, there is a potential for accidents to occur as they participate in the metaverse workflow collaboration.

As set forth herein, a method and system aggregate the physical context of the participants while taking into account potential risks brought about by physical limitations of a participant’s physical environment. This aggregated information is used to create a metaverse collaborative environment that aligns metaverse immersion levels with the participants' physical contexts. A participant that is fully immersed is provided with a virtual reality image that is an image of a simulated digital environment that replaces the real world such that that the image is fully generated using, for example, graphic processors or other devices that create virtual images based on executable drawing instructions. In some examples, a participant that is partially immersed is provided with an augmented reality image that includes overlays of digital elements onto real world image elements and hence shows both a portion of their actual physical environment (from a live camera feed or graphic representation based on a live camera feed) in addition to graphics objects, such as avatars and other generated graphics that are overlayed on the physical environment image. The system dynamically changes a level of visual immersion in each of the participant’s metaverse space that is displayed in a participant’s metaverse display device based on predicted movement of the participant and/or an object in the physical environment of the participant. This way, participants can interact within the metaverse environment in a manner that considers predicted risks and visualizes their physical surroundings accordingly.

In one implementation, the system dynamically adapts the metaverse environment based on the aggregated physical context of its participants. This includes considerations for physical activities, surrounding risks, based on internet of things (IoT) analytics, among other factors. The system proactively analyzes the physical environment of each participant using for example, IoT sensors, executes digital twin simulations and mobility simulations to predict potential accidental scenarios and dynamically adjusts the immersion level (full or partial) in the metaverse environment based on the identified risks, ensuring safety and context-aware collaboration. Data representing real-world physical context is used for affecting virtual metaverse participant spaces to provide adaptation of a collaborative metaverse environment. In some implementations, the system aggregates physical context of its participants, considering factors such as real-world activities, safety risks, and IoT analytics, thus accommodating for the physical contexts and safety of participants by dynamically predicting and changing the level of immersion and visualization in each of the participant’s metaverse space.

In some implementations, a computing system, employs one or more processors and one or more computer-readable storage media that has program instructions stored on the one or more storage media to cause the one or more processors to perform certain operations. In some implementations, the operations include receiving physical data related to a physical environment for each of a plurality of participants, determining a level of virtual immersion for each of the plurality of participants based on activities of each of the plurality participants in the metaverse, the physical data received and safety threshold data associated with the physical environment for each of the plurality of participants, predicting movement of at least one object in the physical environment of one of the participants based the safety threshold data and based on mobility data associated with the object; monitoring a metaverse collaboration between each of the plurality of participants, and changing the level of the virtual immersion for at least one of the plurality of participants based on the predicted movement of the at least one object.

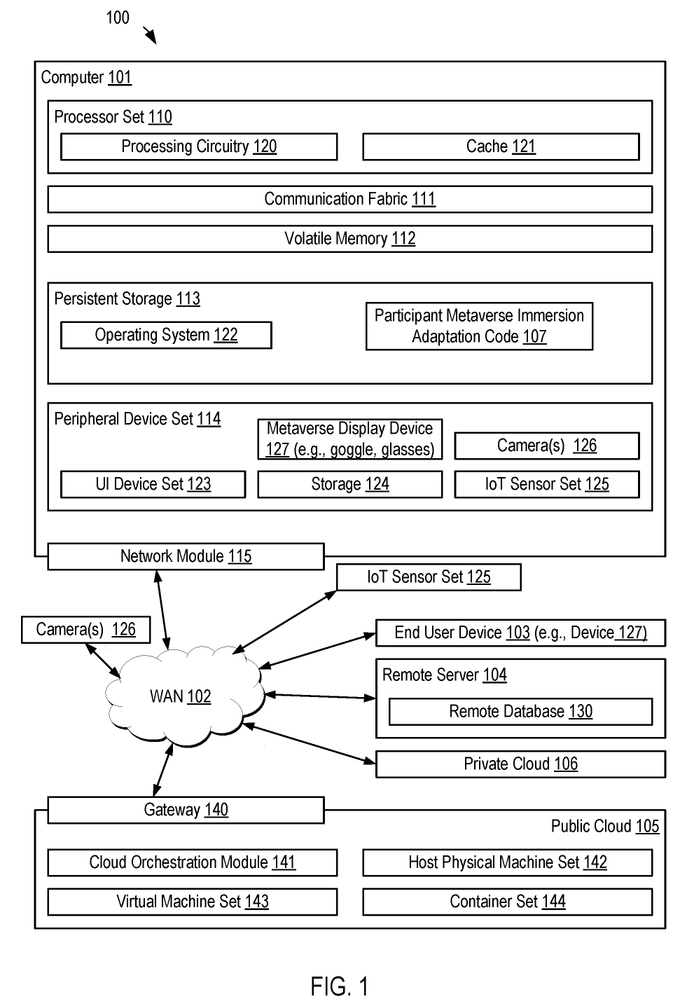

FIG. 1 sets forth an example computing environment according to aspects of the present disclosure. Computing environment 100 contains an example of an environment for the execution of at least some of the computer code involved in performing the various methods described herein, such as participant metaverse immersion adaptation code 107. The participant metaverse immersion adaptation code 107 causes one or more processors to aggregate the physical context of the participants while taking into account potential risks brought about by physical limitations of a participant’s physical environment. This aggregated information is used to create a metaverse collaborative environment that aligns metaverse immersion levels with the participants' physical contexts. The system dynamically changes a level of visual immersion (e.g., changes display images) in each of the participant’s metaverse space that is displayed on a participant’s metaverse display device. In addition to block 107, computing environment 100 includes, for example, computer 101, wide area network (WAN) 102, end participant device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 including participant interface (UI) device set 123, storage 124, Internet of Things (IoT) sensor set 125, camera(s) 126, metaverse display device 127 (e.g., virtual reality (VR) headset, glasses), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End participant device (EUD) 103 is any computer system that is used and controlled by an end participant (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end participant, this recommendation would typically be communicated from network module 115 of computer 101 through WAN 102 to EUD 103. In this way, EUD 103 can display, or otherwise present, the recommendation to an end participant. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the participant. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated participant-space instances, called containers. These isolated participant-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Cloud computing services and/or microservices (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to participants through the internet. Cloud services facilitate the flow of participant data from front-end clients (for example, participant-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

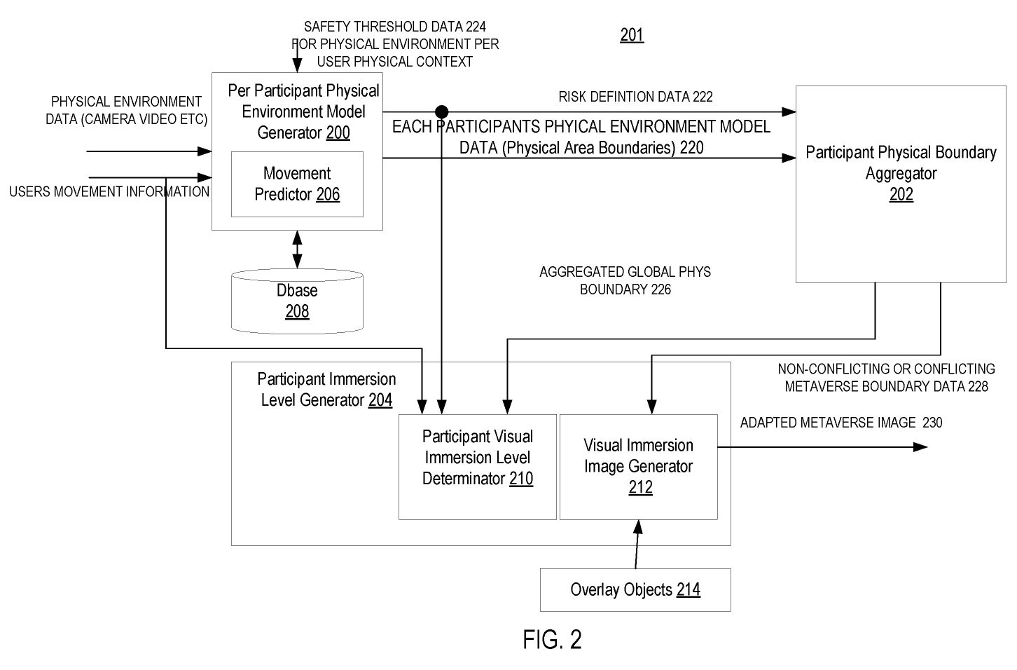

FIG. 2 sets forth a block diagram illustrating an example of a virtual immersion adaptor 201 such as one or more processors of the processor set 110 executing the participant metaverse immersion adaption code 107, however any suitable structure may be employed. In this example, the virtual immersion adaptor 201 executes code modules, and employs one or more databases. In this example, the virtual immersion adaptor 201 includes a per participant physical environment model generator 200, database 208, participant physical boundary aggregator 202, and participant immersion level generator 204. It will be recognized that the operations described may be combined or separated as desired. In this example, the participant immersion level generator 204 includes a participant visual immersion level determinator 210 and a visual immersion image generator 212. The visual immersion image generator 212, in one example is called to produce a fully immersive virtual display environment for a participant, or a partially immersed metaverse environment for a participant, such as by providing augmented reality images using overlay objects 214. In some examples, the visual immersion image generator 212 calls one or more graphics processors to render adapted metaverse images 230 (e.g., computer generated images and/or augmented reality images) as set forth herein.

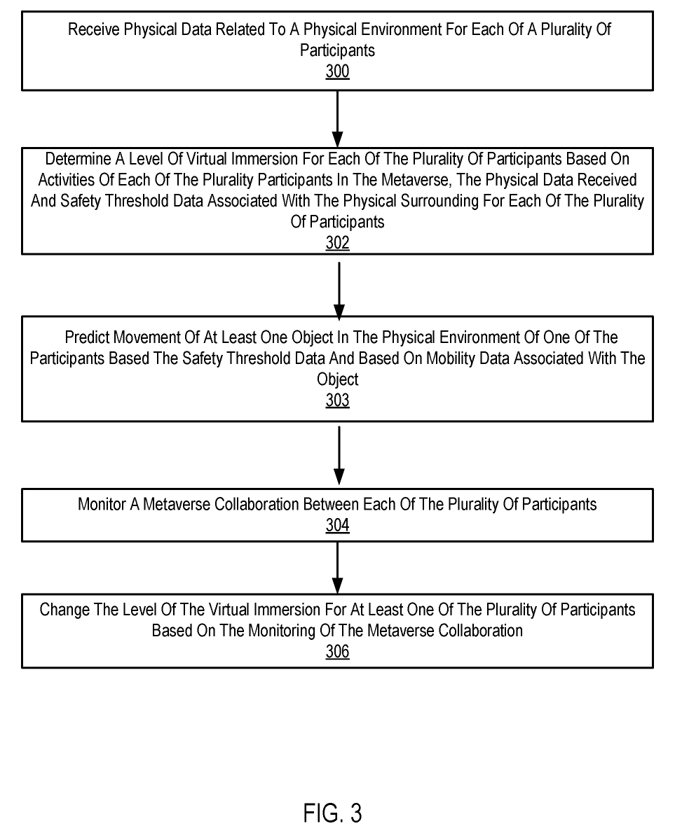

Referring also to FIG. 3, the operation of FIG. 2 will be described. FIG. 3 sets forth a method for adapting metaverse environments based on aggregated physical contexts of participants such as carried out by one or more processors. As shown in block 300 the method includes receiving physical data related to a physical environment for each of a plurality of participants. As shown in block 302 the method includes determining a level of virtual immersion for each of the plurality of participants based on activities of each of the plurality participants in the metaverse, the physical data received, such as from the sensors and camera feeds and the safety threshold data associated with the physical environment for each of the plurality of participants. As shown in block 303, the method includes predicting movement of at least one object in the physical environment of one of the participants based the safety threshold data and based on mobility data associated with the object. For example, as described further below, the mobility data in one example, includes data representing a predicted movement location of the object such as the participant and/or an object in the physical environment of the participant. As shown in block 304 the method includes monitoring a metaverse collaboration between each of the plurality of participants. As shown in block 306 the method includes changing the level of the virtual immersion for at least one of the plurality of participants based on the predicted movement of the object.

Referring again to FIG. 2 in one example, the per participant physical environment model generator 200 identifies different types of accident scenarios, risky situations, presence of obstacles, and/or moving object trajectory in any given physical surrounding from where a participant will participate in a metaverse workflow. For example, the per participant physical environment model generator 200 analyzes the given physical surrounding for risky situations, obstacles, and potential accidental scenarios detection. In some examples, the system employs a smart physical area, like in a smart home, office, work floor or other smart area, such that a network of IoT sensors are installed strategically within the physical environment. These sensors may include motion detectors, cameras, temperature sensors, proximity sensors, and any other relevant sensors. The received data is stored in the database 208 for use in determining physical areas that be or become safety hazards.

In one example, cameras are placed in the physical area and provide real-time video feeds. These cameras are positioned to cover critical areas where accidents or risky situations might occur. The system also gathers the data from sensors such as from machines, devices, or vehicles that are part of the physical environment. This data might include machine states, positions, and mobility patterns. The system aggregates the data from the IoT sensors, camera feeds, and machine data into a centralized system or database for processing.

In one example, the system uses computer vision techniques to detect objects, people, and movements in real-time, with image recognition to identify specific objects or hazards (e.g., hazardous chemicals, obstacles, moving machinery). In some examples, the system applies object tracking algorithms to monitor the trajectories of moving objects and individuals, for example, an ML-RANSAC algorithm or other suitable algorithm.

In one example, the system uses artificial intelligence (AI) and/or machine learning models to assess safety risks based on the data collected, and recognize patterns associated with risky situations, such as objects that become or are in dangerous proximity to machinery, the participant or other objects. Where temperature sensors are used, sudden temperature changes are detected as safety hazards. For example, the system uses one or more anomaly detection algorithms to identify deviations from normal operating conditions that indicate an accident waiting to happen based on the safety threshold settings.

In one example, per participant physical environment model generator produces model data 220 for each participant that defines the hazardous areas of a participant’s physical area and risk definition data 222 that identifies a risk level (e.g., 0-4) indicating how much risk is currently detected for a given participant. In one example, where the risk definition data 222 indicates no risk (risk level 0), a fully immersed metaverse environment is provided for that participant. Different levels of immersion are provided for different levels of risk. For example, the most high level of risk, such as risk level 4, the partial immersion level produces an augmented reality environment that shows nearly all of the participants live camera feed with just a few overlaid objects whereas a lower risk level provides less of the live feed and then more computer generated objects. In some implementations, the system uses the movement predictor 206 that employs a digital twin of the physical environment. This virtual representation closely mimics the real-world environment. The system uses the digital twin environment to simulate various scenarios, including the movement of objects, people (also referred to as object herein), and environmental conditions to predict for example how much future movement of an object or person will cause a safety hazard. The system uses the digital twin to predict potential accidental scenarios by running simulations and analyzing results. This prediction is used to then adjust the immersion level when actual movement is detected to avoid an actual safety issue for a participant. The movement predictor 206 also uses the live feed to predict movement of objects and/or people so that changes in movement that can cause a safety risk are identified in real time.

The safety threshold data 224 serve as set predefined thresholds for risk factors and used to identify potential accidental scenarios for physical environments. They are set for each participant’s physical environment. In some examples these thresholds are set using national local safety standard data. In other examples these thresholds are based on the AI analysis and simulation results.

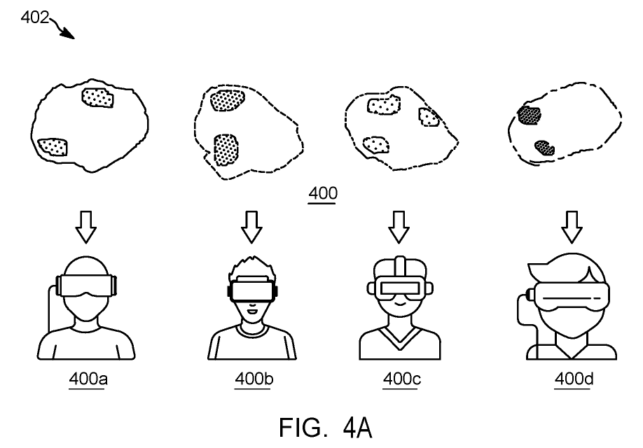

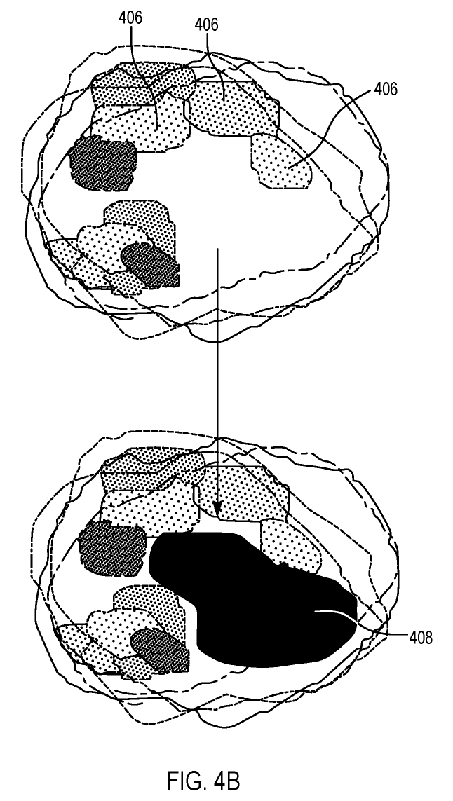

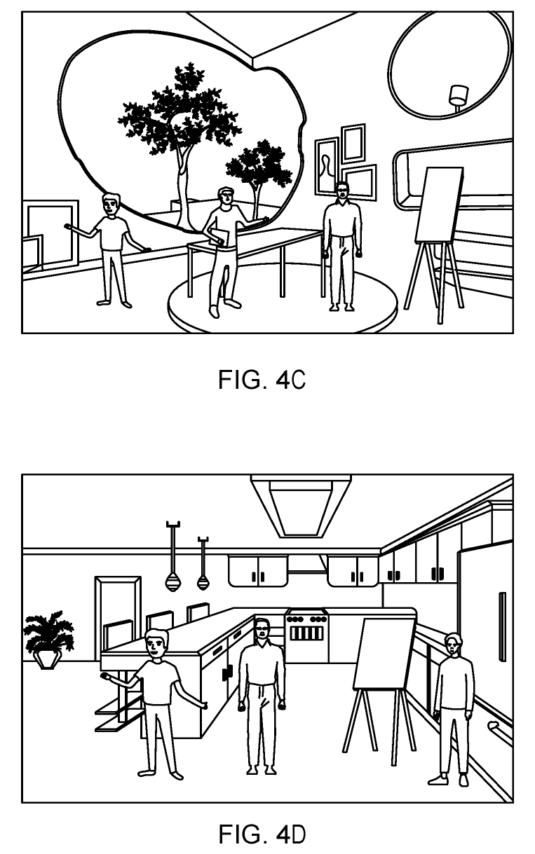

In some examples, the per participant physical environment model generator 200 classifies the physical surroundings of a participant based on different types of possible risky situations, accident scenarios, trajectory of movement of objects and/or people in the physical environments, and creates the physical environment model data 220 (also shown as physical areas 404 in FIG. 4A) which is the physical area boundary for each participant based on safety threshold data to segment the physical area into areas of safe space and each overall physical boundary area is tagged with risk definition data 222 accordingly.

In one example, for each and every participating participant of the metaverse, the system identifies the physical location from where the participant is attending the metaverse collaboration, and generates the physical area boundaries that take into account hazard areas and/or potential hazardous conditions within the physical environment of each participant. The per participant physical environment model generator 200 identifies each participating participant physical surrounding, and with respect to each and every participant, and identifies the risky area, accident prone area, mobility trajectory of any object and provides the physical area boundaries 220 to the participant physical boundary aggregator 202 along with corresponding risk definition data 222 for each physical area boundary.

The participant physical boundary aggregator 202 aggregates the physical surrounding specification of each of the participating participants to identify the effective surrounding in metaverse workflow and produces an aggregated global physical boundary 226 (also shown as 406 in FIG. 4B). For example, the participant physical boundary aggregator 202 aggregates the physical surrounding risky area, for different participating participants and identifies which portion of the aggregated surrounding can be safe for any participant. The aggregated surrounding from each participant is used to identify how the metaverse workflow environment is designed, so that no participating participant can get in the hazardous portions which are the non-conflicting or conflicting metaverse boundary information 228 for the collaboration (shown as area 408 in FIG. 4B). Based on the identified restricted space, the system creates the metaverse workflow environment, so that no participant can get on the conflicting location, where at least one participant can have a problem. The purpose of creating a common safe area is that each participating participant can view the fully immersed surroundings from a same perspective, and can use this frame of reference during the collaboration in the workflow.

The participant immersion level generator 204 uses the participant visual immersion level determinator 210 to identify risky situations in each participant’s physical area while interacting with metaverse collaborative workflow. For example, while each participant is interacting in the metaverse collaborative workflow, the movement predictor 206, which provides information to the participant visual immersion level determinator 210, analyzes the visual surrounding, IoT feed analysis and with digital twin simulation, to predict if any portion of the activity area that will have a risky situation. The system tracks the activities and positions of participants within the metaverse collaborative environment. This can be achieved through metaverse platforms and tracking technologies.

The system performs synchronization of data from IoT sensors and metaverse tracking to correlate real-world events with virtual interactions. The system identifies risk factors and parameters based on the nature of the physical environment and the metaverse workflow activities. For example, if of a falling tree branch is detected by sensors of a participant that is outside or falling over another walking person, or a participant that is in a factory setting using a cutting machine and the IoT sensors are used to predict that the risk of injury is too high for the worker, versus a scenario where a person that is just sitting on a table and immersed in metaverse collaboration and no risk of injury is present, the participant with no injury risk is provided with a fully immersed metaverse environment compared to a changing from a full immersion to partial immersion for the worker with a potential risk of injury or the person that has a potential of getting hit by the falling branch.

The participant visual immersion level determinator 210 performs proactive transition from a fully immersive workflow environment to an appropriate level of immersive environment for each participant after predicting accident scenarios with key contexts of the metaverse environment. The system performs a proactive transition from a fully immersive metaverse workflow environment to an appropriate level of partially immersive environments after predicting an accidental scenario. The system continuously monitors the metaverse workflow environment and the physical context of participating participants using sensors, AI, and real-time data analysis and uses safety threshold data that, when met, indicate the potential for an accident scenario. The safety threshold data in some examples include data indicating criteria such as unsafe proximity to physical obstacles, unsafe participant actions, and the presence of risky objects or conditions to a participant or other object in a participant’s environment.

The system continuously compares the current state of the metaverse environment and physical context to the predefined safety thresholds and regularly evaluates the risk level for each participant based on the key contexts of the metaverse environment. When the system identifies the predefined thresholds for potential accident scenarios, the system transitions the participant to partially immersive metaverse workflow. For example, the participant visual immersion level determinator 210 analyzes the context of metaverse collaboration workflow and identify which metaverse objects along with the avatars are to be placed on the partially immersive environment for the participant and instructs the visual immersion image generator to generate the appropriate images.

FIGS. 4A-4D set forth a diagram illustrating an example of operations of the participant metaverse immersion adaptor 201. In this example, there are four different participants 400a, 400b,400c and 400d from four different physical locations that are participating in a metaverse collaboration workflow. In this example, different physical locations may have different types of safety risk areas due to obstacles or hazards or other criteria. The system aggregates the different locations and associated risk areas to create a metaverse workflow environment. In this example the system produces a fully immersive metaverse environment shown in FIG. 4C that is created for participant 400b and a partially immersive metaverse environment that is created for participant 400a. Participant 400a has a partially immersive metaverse environment because participant 400a has physical surroundings that have risk factors that have been determined to require participant 400b to be shown the participants actual physical surroundings as part of the metaverse environment as an augmented reality environment with avatars of other participants and graphics objects overlaid on the live camera feed from participants 400a camera.

For example, in operation, the system generates physical area boundaries 402 for each participant based on physical environment safety risk classification data for each of the plurality of participants. In one example the safety risk classification data is based on a prediction of safety risk areas within a physical area of each participant, and based on mobility data associated with an object in the physical area of each participant. For example, the system calculates different physical three-dimensional physical area boundaries for respective participants of the metaverse environment taking into account that each participant needs to move (perform mobility based operations) to interact in the metaverse collaboration environment. The system performs visual analysis from camera feeds, analysis based on sensors such as from Internet of Things sensors, along with digital twin simulation to predict safe areas within a user's physical environment and/or identify the areas of risk within a particular user's physical environment. In this example the risky areas 404 in each participant’s physical environment are identified for each participant. For example, in this example the system identifies portions of the physical area for each participant, where there will be risky areas for a given participant in their physical environment.

As shown in FIG. 4B the system aggregates 406 the generated physical area boundaries of the participants, namely the risk areas and identifies either a non-conflicting metaverse boundary 408 or a conflicting metaverse boundary for the collaboration. The system identifies the aggregated physical areas of different participants to identify how the metaverse environment is to be designed, so that for each participant, they can perform movement, so no participant will be impacted because of their respective physical area. As shown in FIG. 4C since there is an metaverse environment for participant 400b where there are no risk areas within a predicted distance from where participant 400b will likely be moving, a full immersive metaverse is created and display on participant 400b virtual display device. Participant 400b’s physical surrounding is secure, so that participant can see fully immersive environments for the metaverse collaboration. In this example, the system produces the metaverse environment for a workflow based the non-conflicting metaverse boundary 408.

As shown in FIG. 4D, unlike the participant in FIG. 4C, participant 400a's physical surrounding has a detected risk factor so that for this participant, a partially immersive environment is created which in this example is an augmented reality output that includes context based metaverse objects that are overlaid over a live image of the physical environment of participant 400a. In this example, avatars are shown to be overlaid, as well as a presentation board that is overlaid over a real time view of participant 400a's kitchen. In contrast, the output produced by the system that is displayed for user 400b as shown in FIG. 4C illustrates a fully immersive computer generated metaverse environment.

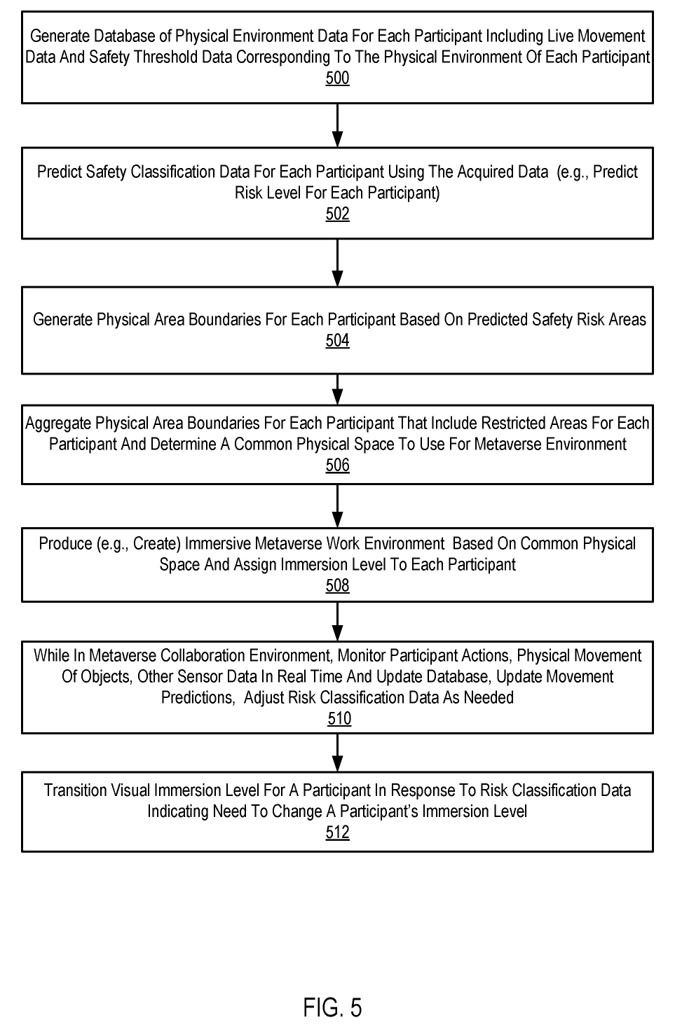

Referring also to FIG. 5, a flowchart is shown illustrating an example of a method for adapting metaverse environments based on aggregated physical contexts of participants. The method includes, as shown in block 500, generating a database, such as database 208, that includes the physical environment data for each participant including live movement data and safety threshold data corresponding to the physical environment of each participant. As shown in block 502 the method includes predicting safety classification data for each participant using the acquired data, for example predicting safety risk levels for each participant. In one example, as noted above, this includes using artificial intelligence or other suitable prediction algorithms to assess a participant’s safety risks based on collected live data (e.g., camera data, sensor data) that is used to detect movement or other changing safety conditions in a participant’s physical environment. In one example this includes using digital twin modeling to predict potential safety risks based on predicted movement and/or actual movement of objects and/or participants in their physical environments.

As shown in block 504, the method includes generating physical area boundaries for each participant based on predicted safety risk areas within a participant's physical environment. For example, the system evaluates each participant’s physical area and identifies safety risks within the area designating areas that our safety risks as being not available for a participant to move into. As shown in block 506, the method includes aggregating physical area boundaries for each participant that include restricted areas for each participant, and determining a common physical space to use for the metaverse environment for the workflow. For example, the system identifies which portion of each participant’s physical surroundings can be used during the metaverse workflow. This information is combined to determine an area that, in one example, is clear for all participants so that if possible, all participants get a fully immersed metaverse environment displayed to them.

As shown in block 508, the method includes producing (e.g., create) immersive metaverse work environment based on the common physical space and assign immersion level to each participant. As shown in block 510, the method includes while in a metaverse collaboration environment, monitoring participant actions, physical movement of objects, and/or other sensor data in real time and update the database, update movement predictions, adjust risk classification data as needed. As shown in block 512, the method includes transitioning a visual immersion level for a participant in response to risk classification data indicating a need to change a participant’s immersion level. For example, if an object moves toward a user or a user moves toward an object that is determined to violate a safety threshold, in one example the user is sent a notification visually or audibly that an accident is about to occur, and the user’s immersion level is changed so that the actual live feed of the user’s environment is presented with overlaid objects associated with the metaverse workflow as an augmented reality image so that the user is aware of the potential risk visually.

Stated another way, as set forth above, the system considers the physical context of each participating participant. This includes considering the physical activities being performed by the participants, their physical surroundings, the mobility of various machines and devices in their respective physical locations and predicting any potential collisions or accident scenarios in those physical locations, and accordingly, during the construction of the collaborative metaverse environment, the system will aggregate the identified physical contexts and adapt the metaverse workflow environment accordingly for the participants.

Based on the context of the respective physical environments, the predicted level of risk factors from the surrounding objects, and the types of physical activities that the respective participating participants are engaged in, the system dynamically determines whether the collaborative metaverse workflow environment should be fully immersive or offer different levels of partial immersion should be applied for different participants.

The system identifies what level of partial immersion is appropriate for each participant. The system extracts key visual elements such as participating avatars and 3D objects from the metaverse workflow, and these visuals will then be overlaid onto the respective participating participant's physical environment. This way, while remaining in their physical environment, participants can also interact with the collaborative metaverse workflow, while the other participating participants can continue to be present in the fully immersive metaverse workflow environment.

In some examples, while participants are engaging in a metaverse collaboration from their respective physical environments, the system continually analyzes the context of these physical locations, that includes visual recognition techniques, IoT data analysis, digital twin simulations of the mobility or stationary machines around those physical locations to identify any potential accident scenarios in any of these physical locations, and accordingly based on predefined threshold limits of accident scenarios with respect to the physical locations, thee system proactively transitions to an appropriate level of partial immersion in the metaverse workflow environment.

In some examples, based on the analysis of each participant's physical location, the system categorizes areas that contain obstacles, are predicted high-risk zones, and considers the mobility paths of surrounding machines. The system consolidates the 3D spaces of these individual physical locations to determine the design of the metaverse's 3D space so that the participating participants can effectively collaborate within the metaverse collaborative environment.

Example of physical obstacles include for example, obstacles in a participant’s physical space that they are not aware of while fully immersed in a metaverse collaboration workflow. To avoid collisions, the system uses data from mechanisms that detect and alert participants about potential obstacles. Accident scenarios can occurs since participants that are engaged in a fully immersive metaverse workflow experience may inadvertently cause or find themselves in accidental scenarios, such as about to walk into a wall or trip over objects. The system provides different immersion levels to participants to prevent harm. Unlike conventional system, the disclosed system employs real-time safety risk assessment based on predicted motion and safety thresholds associated with the environment.

In some examples, the system provides notifications to participants when they approach safety boundaries. In some examples, for AI systems that establish threshold limits for safe interactions in the metaverse, the system proactively transitions participants to a less immersive environment. The system has a type of built-in emergency protocol that allows participants to exit the virtual world swiftly from the workflow in the event of an emergency in the physical environment by providing notification and/or transitioning to a partially or fully non-immersive environment.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for providing intelligent workflow in a metaverse environment, the method comprising:
receiving physical data related to a physical environment for each of a plurality of participants;
determining a level of virtual immersion for each of the plurality of participants based on activities of each of the plurality participants in the metaverse environment, the received physical data and safety threshold data associated with the physical environment for each of the plurality of participants;
predicting movement of at least one object in the physical environment of one of the participants based the safety threshold data and based on mobility data associated with the object;
monitoring a metaverse collaboration between each of the plurality of participants; and
changing the level of virtual immersion for at least one of the plurality of participants based the predicted movement of the at least one object.

2. The method of claim 1 wherein predicting movement of the at least one object comprises providing one or more safety recommendations to at least one or more of the plurality of participants based on a mobility prediction of a participant, in response to monitoring the metaverse collaboration.

3. The method of claim 1 wherein changing the level of the virtual immersion for at least one of the plurality of participants based on the monitoring of the metaverse collaboration comprises transitioning at least one of the plurality of participants to a different level of immersion and creating a corresponding metaverse display portion for the participant that comprises a different amount of augmented reality corresponding to the different level of immersion.

4. The method of claim 1 comprising:
generating physical area boundaries for each participant based on physical environment safety risk classification data for each of the plurality of participants that is based on a prediction of safety risk areas within a physical area of each participant, and based on mobility data associated with an object in the physical area of each participant;
aggregating the generated physical area boundaries of the participants and identifying one of a non-conflicting metaverse boundary or a conflicting metaverse boundary for the collaboration; and
producing the metaverse environment for a workflow based on one of the non-conflicting or conflicting metaverse boundaries.

5. The method of claim 4 comprising generating the physical environment safety risk classification data by:
generating a digital twin model of a physical area of each participant and simulate differing scenarios involving at least movement of objects; and
predicting a potential safety risk area for a participant based on the generated digital twin model.

6. The method of claim 1 comprising changing from a first level of partial immersion to a second level of partial immersion based on predicted movement of an object in a physical environment of a participant.

7. The method of claim 1 wherein monitoring the metaverse collaboration comprises:
identifying a safety risk condition based on the safety threshold data for at least one of the participants in response to a change in movement of a participant or object in the physical environment of an associated participant; and
in response to a detected safety risk, changing the level of visual immersion for the participant in the metaverse environment to a partial visual immersion.

8. A computer system comprising:
a processor set;
one or more computer-readable storage media; and
program instructions stored on the one or more storage media to cause the processor set to perform operations comprising:
receiving physical data from one or more sensors, related to a physical environment for each of a plurality of participants;
determining a level of virtual immersion for each of the plurality of participants based on activities of each of the plurality participants in the metaverse environment, the physical data received and safety threshold data associated with the physical environment for each of the plurality of participants;
predicting movement of at least one object in the physical environment of one of the participants based the safety threshold data and based on mobility data associated with the object;
monitoring a metaverse collaboration between each of the plurality of participants; and
changing the level of the virtual immersion for at least one of the plurality of participants based on the predicted movement of the at least one object.

9. The computer system of claim 8 wherein the one or more computer-readable storage media comprises program instructions stored on the one or more storage media to cause the processor set to perform operations comprising: providing one or more safety recommendations to at least one or more of the plurality of participants based on a mobility prediction of a participant, in response to monitoring the metaverse collaboration.

10. The computer system of claim 8 wherein the one or more computer-readable storage media comprises program instructions stored on the one or more storage media to cause the processor set to perform operations comprising transitioning at least one of the plurality of participants to a different level of immersion and creating a corresponding metaverse display portion for the participant that comprises a different amount of augmented reality corresponding to the different level of immersion.

11. The computer system of claim 8 wherein the one or more computer-readable storage media comprises program instructions stored on the one or more storage media to cause the processor set to perform operations comprising:
generating physical area boundaries for each participant based on physical environment safety risk classification data for each of the plurality of participants that is based on a prediction of safety risk areas within a physical area of each participant, and based on mobility data associated with an object in the physical area of each participant;
aggregating the generated physical area boundaries of the participants and identifying one of a non-conflicting metaverse boundary or a conflicting metaverse boundary for the collaboration; and
producing the metaverse environment for a workflow based on one of the non-conflicting or conflicting metaverse boundaries.

12. The computer system of claim 11 wherein the one or more computer-readable storage media comprises program instructions stored on the one or more storage media to cause the processor set to perform operations comprising:
generating a digital twin model of a physical area of each participant and simulate differing scenarios involving at least movement of objects; and
predicting a potential safety risk area for a participant based on the generated digital twin model.

13. The computer system of claim 8 wherein the one or more computer-readable storage media comprises program instructions stored on the one or more storage media to cause the processor set to perform operations comprising changing from a first level of partial immersion to a second level of partial immersion based on predicted movement of an object in a physical environment of a participant.

14. The computer system of claim 8 wherein the one or more computer-readable storage media comprises program instructions stored on the one or more storage media to cause the processor set to perform operations comprising:
identifying a safety risk condition based on the safety threshold data for at least one of the participants in response to a change in movement of a participant or object in the physical environment of an associated participant tracking activity of a participant within the metaverse collaborative environment; and
in response to a correlation conflict with risk threshold data, changing the level of visual immersion for the participant in the metaverse environment.

15. A computer program product comprising:
one or more computer-readable storage media; and
program instructions stored on the one or more storage media to perform operations comprising:
receiving physical data from one or more sensors, related to a physical environment for each of a plurality of participants;
determining a level of virtual immersion for each of the plurality of participants based on activities of each of the plurality participants in the metaverse environment, the physical data received and safety threshold data associated with the physical environment for each of the plurality of participants;
predicting movement of at least one object in the physical environment of one of the participants based the safety threshold data and based on mobility data associated with the object;
monitoring a metaverse collaboration between each of the plurality of participants; and
changing the level of the virtual immersion for at least one of the plurality of participants based on the predicted movement of the at least one object.

16. The computer program product of claim 15 wherein the one or more computer-readable storage media comprises program instructions stored on the one or more storage media to cause one or more processors to perform operations comprising providing one or more safety recommendations to at least one or more of the plurality of participants based on a mobility prediction of a participant, in response to monitoring the metaverse collaboration.

17. The computer program product of claim 15 wherein the one or more computer-readable storage media comprises program instructions stored on the one or more storage media to cause one or more processors to perform operations comprising transitioning at least one of the plurality of participants to a different level of immersion and creating a corresponding metaverse display portion for the participant that comprises a different amount of augmented reality corresponding to the different level of immersion.

18. The computer program product of claim 15 wherein the one or more computer-readable storage media comprises program instructions stored on the one or more storage media to cause one or more processors to perform operations comprising:
generating physical area boundaries for each participant based on physical environment safety risk classification data for each of the plurality of participants that is based on a prediction of safety risk areas within a physical area of each participant, and based on mobility data associated with an object in the physical area of each participant;
aggregating the generated physical area boundaries of the participants and identifying one of a non-conflicting metaverse boundary or a conflicting metaverse boundary for the collaboration; and
producing the metaverse environment for a workflow based on one of the non-conflicting or conflicting metaverse boundaries.

19. The computer program product of claim 15 wherein the one or more computer-readable storage media comprises program instructions stored on the one or more storage media to cause one or more processors to perform operations comprising:
generating a digital twin model of a physical of each participant and simulate differing scenarios involving at least movement of objects; and
predicting a potential safety risk area for a participant based on the generated digital twin model.

20. The computer program product of claim 15 wherein the one or more computer-readable storage media comprises program instructions stored on the one or more storage media to cause one or more processors to perform operations comprising:
identifying a safety risk condition based on the safety threshold data for at least one of the participants in response to a change in movement of a participant or object in the physical environment of an associated participant tracking activity of a participant within the metaverse collaborative environment; and
in response to a correlation conflict with risk threshold data, changing the level of visual immersion for the participant in the metaverse environment.
